(19) United States
(12) Patent Application Publication
(10) Pub. No.: US 2023/0230002 A1
(43) Pub. Date: Jul. 20, 2023

(54) SUPPLY CHAIN MANAGEMENT WITH INTELLIGENT DEMAND ALLOCATION AMONG MULTIPLE SUPPLIERS

(71) Applicant: Dell Products L.P., Round Rock, TX (US)

(72) Inventors: Shibi Panikkar, Bangalore (IN); Robit Gosain, Bangalore (IN); Ajay Maikhuri, Bangalore (IN)

(21) Appl. No.: 17/577,185

(22) Filed: Jan. 17, 2022

(51) Int. Cl. G06Q 10/06; G06Q 10/08; G06Q 30/02

(52) U.S. Cl. CPC G06Q 10/06315; G06Q 10/087; G06Q 30/0202

(57) ABSTRACT

Automated supply chain management techniques are disclosed. For example, a method comprises the following steps. The method obtains a demand for a given number of an item associated with a manufacturing order. The method obtains a set of classifications for a set of suppliers based on historical data corresponding to each of the suppliers, and obtains a criticality indicator for the demand. The method generates an allocation for the demand across at least a subset of the set of suppliers based on the set of classifications and the criticality indicator, wherein each of the suppliers in the subset is allocated a given proportion of the demand in accordance with the generated allocation.

### FIELD

The field relates generally to information processing systems, and more particularly to supply chain management in such information processing systems.

### DESCRIPTION

Supply chain management in the manufacturing industry typically refers to the process of monitoring and taking actions required for the manufacturer, such as an original equipment manufacturer (OEM), to obtain raw materials, and convert those raw materials into a finished product (equipment) that is then delivered to or otherwise deployed at a customer site. A goal of supply chain management with respect to the raw materials is to adequately balance supply and demand, e.g., the supply of the raw materials (the raw materials procured or otherwise acquired from vendors, etc.) with the demand of the raw materials (e.g., the raw materials needed to satisfy the manufacturing of equipment ordered by a customer). Raw material shortage has been a challenge in the traditional (and even now modern) supply chain process. Furthermore, purchasing raw materials from a single supplier can be risky and even lead to monopolization.

### SUMMARY

Illustrative embodiments provide automated supply chain management techniques in an information processing system.

For example, in an illustrative embodiment, a method comprises the following steps performed by at least one processing device comprising a processor coupled to a memory when executing program code. The method obtains a demand for a given number of an item associated with a manufacturing order. The method obtains a set of classifications for a set of suppliers based on historical data corresponding to each of the suppliers, and obtains a criticality indicator for the demand. The method generates an allocation for the demand across at least a subset of the set of suppliers based on the set of classifications and the criticality indicator, wherein each of the suppliers in the subset is allocated a given proportion of the demand in accordance with the generated allocation.

In one or more additional illustrative embodiments, the method enables adjustment to the generated allocation based on at least one of a user input and supply market value data.

Advantageously, one or more illustrative embodiments provide automated supply chain management techniques that determine a ratio or proportion to divide the total demand among suppliers based on a demand mode (i.e., criticality indicator of the demand), supplier response attributes (i.e., variability attributes), and supplier behavior with market change (i.e., supply market value).

These and other illustrative embodiments include, without limitation, apparatus, systems, methods and computer program products comprising processor-readable storage media.

### BRIEF DESCRIPTION OF THE DRAWINGS

FIG. 1 illustrates an automated supply chain management environment with intelligent demand allocation among multiple suppliers according to an illustrative embodiment.

FIG. 2 illustrates a graphical example of classification of suppliers according to an illustrative embodiment.

FIG. 3 illustrates a tabular example of classification of suppliers according to an illustrative embodiment.

FIG. 4 illustrates a proportion derivation methodology of an intelligent demand allocation system according to an illustrative embodiment.

FIG. 5 illustrates a proportion adjustment methodology of an intelligent demand allocation system according to an illustrative embodiment.

FIG. 6 illustrates an example of a processing platform that may be utilized to implement at least a portion of an information processing system for automated supply chain management with intelligent demand allocation among multiple suppliers according to an illustrative embodiment.

### DETAILED DESCRIPTION

Effective sourcing of raw materials from suppliers is useful in the manufacturing industry. As mentioned above in the background section, purchasing all materials from a single supplier is risky and can lead to a monopoly. To overcome that, OEMs purchase the same part (i.e., raw material required for manufacturing a system) from multiple suppliers by dividing the demand among them to mitigate the business risk. As there are multiple suppliers, the OEM tries to make sure that certain percentages are distributed among the multiple suppliers. This is to ensure that at a time of crisis (supply disruption or shortage), the OEM gets full support/commitment from the suppliers and also avoids supply monopolization.

However, it is realized herein that this raises the question as to what proportion of the total demand (sometimes referred to as the total available market or TAM) should be allocated to each supplier. In conventional approaches, the supplier division proportion of the demand is derived manually by a human supply planner (e.g., global commodity manager or GCM) based on factors such as the experience of the supplier, the relationship with the supplier, price, and capability of the material supply.

Thus, there is no systematic approach behind the conventional supplier percentage allocation, but rather the conventional approach is based on the manual judgment and/or preference of the supply planner who is either selecting suppliers based on personal experience and/or on some manually-interpreted supplier analytics. Once the supply planner defines the percentage of proportion in the supply planning, it typically remains static for multiple runs.

However, it is realized herein that each supplier is different. Each supplier delivers parts in different ways. For example, some suppliers always deliver parts on time, some deliver with 20% delay, some with 30% delay, some with higher prices, some with flexible price, etc. Assume herein that these differences in supply attributes are referred to as supplier response attributes. Further, assume that demand mode is a term that indicates the criticality of a parts order. If a demand mode is very-critical, and the demand goes to a supplier that normally delivers late, then this creates risk for the OEM. Furthermore, when demand is low-critical, and demand goes to a high-priced but on-time delivering supplier, the OEM will incur a financial loss.

Note further that it is realized herein that the same part can be used in different demand modes. For example, the same part can be used for a high-critical demand (e.g., build to order, large order) and a low-critical demand (e.g., build to stock). Still further, it is realized herein that demand mode of forecasted orders in each supply run are different. Thus, this variability greatly affects the level of risk in supply planning. OEMs conventionally manage the risk using a high safety stock. Safety stock is an extra quantity of a material which is procured by the OEM and stored at a manufacturing location (e.g., a factory) to prevent an out-of-stock situation.

Also, it is realized herein that factors such as supplier capability, market value, new suppliers in the market, as well as which supplier supplies the same material at a better price, are not adequately considered when demand is divided in a conventional manner. Accordingly, the conventional static percentage division of the supply demand causes inefficient raw material procurement, which can result in a part shortage or a last-minute buy which is costly.

To further illustrate the technical problems with conventional demand percentage allocation among suppliers, consider the following example.

Assume that an OEM has five large orders forecasted for next quarter. The orders must be delivered within two months and includes 500 systems (units of equipment). All these systems demand high value part X. Each system needs two X parts, so the total demand of X is 1000. The order will go to manufacturing factory F and the safety stock (stock maintained for meeting unexpected demand) of part X in the factory F is 100. However, assume that supply planners do not want to consume anything from safety stock (keep the safety stock as it is), so although the actual deficiency is 900 parts, a demand of 1000 parts will be raised.

Further assume that there are six suppliers for supplying part X, i.e., suppliers S1, S2, S3, S4, S5 and S6, but that the maximum number of suppliers to be considered for the proportion division is four. OEM supply planner has a strong relationship with suppliers S3, S4 and S5, but supplier S1 offers part X at a low price. Conventionally, based on relationship and price, the supply planner gives a larger percentage of the 1000 part demand to S3, S4 and S5 and because of the low-priced offer, the remainder goes to S1. For example, the supply planner would give 30%, 30%, and 30% to S3, S4, and S5, respectively (300 each). The remaining 10% goes to S1 (100) because of the low price. In the conventional approach, this division is static for part X for any type of order, and since the supply planner has no view and variability of demand modes and supplier response attributes, the supply planner is not aware of the risk in this particular allocation.

Suppose S3 and S4 each have a historical delay probability of 30% of the demand, while S5 has a historical delay probability of 20% of the demand. Historical delay probability can be considered herein a supplier response attribute. In the conventional approach, this attribute is not visible to the supply planner as manually viewing information to learn of this attribute is near to impossible for millions of parts in a global OEM.

So, for 900 parts, S3 and S4 combined may impose 600×30/100=180 parts at risk, and S5 may impose 300×20/100=60 parts at risk. Thus, unbeknownst to the supply planner, there is a total of 240 parts at risk based on the supplier allocation made. Note also that this supplier response attribute (historical delay probability) is only for part X, and it may not be the case for other parts a supplier ships, i.e., maybe part Y historically ships on time or perhaps part Y has an even larger delay probability.

In any event, based on the assumed delay percentages and a safety stock of 100, there is a good chance that order fulfillment is at risk and the OEM will experience a deficiency for part X. Assuming that the OEM could exhaust the safety stock, then there would still be 140 parts at risk. If the OEM had a safety stock of 250 parts rather than 100, the OEM would be fine because the safety stock could be used to process the order. If the mode of demand is flexible, then the OEM would also be fine, since they could recalculate the delivery time and inform the customer that there is a part shortage due to a supply delay.

Illustrative embodiments overcome the above and other technical problems by providing technical solutions comprising automated supply chain management techniques that intelligently determine a demand allocation (e.g., ratio, proportion, percentage, or the like) to divide the total demand among suppliers based on variability factors comprising a demand mode, one or more supplier response attributes, and a supplier behavior with regard to market change. More particularly, illustrative embodiments consider, inter alia, different demand modes and supplier response attributes for each demand mode, wherein the demand mode may vary for each supply run whereas different market fluctuations and the ability of a supplier to meet the demand may vary less frequently. As will be further explained below, the demand allocations are computed using one or more machine learning (ML) or other artificial intelligence-based algorithms.

Different demand modes can be designated based on order needs or preferences of the entity that manages the demand. Still further, modes of demand may be categorized differently across different industries. By way of one example only, demand modes could be defined as follows: (i) criticality-low: e.g., an order forecast, a build to stock order; (ii) criticality-medium: e.g., a build to order; and (iii) criticality-high: e.g., a configure to order, a large order, a must arrive by date order.

The above illustrative demand modes can also warrant definitions based on parts: (i) high value parts which are very important to get on time (criticality-high orders); (ii) high value parts which have adequate safety stock (parts that are stocked in manufacturer's location) so that some delay is not an issue (criticality—medium orders); (iii) low value parts which is important to get on time (criticality—high orders); (iv) low value parts which can be delayed (criticality-low orders); (v) parts that are needed for critical anticipated orders (criticality-high orders); and (vi) parts that are needed for must arrive by date where the customer sets the time of delivery (criticality-high orders). It is to be appreciated that these categorizations are only examples and illustrative embodiments described herein are not intended to be limited to any specific demand mode definitions.

Now consider how suppliers behave (supplier response attributes) with respect to a given demand mode definition for a specific part X assuming the plurality of suppliers include suppliers S1, S2, S3, S4, S5 and S6. Examples of supply response attributes may include the following: (i) delivery attribute (with values, e.g., on time, 20% delay, 30% delay, real-time delivery capability); (ii) payment attribute (with values, e.g., supports fix pay option, supports flexible pay option); (iii) part rejection attribute (e.g., with values, e.g., less than 1%, between 1% and 5%, more than 5%); (iv) price attribute (with values, e.g., low, high); and (v) relationship attribute (with values, e.g., good, average, bad; or no relationship and relationship)

Still further, for different demand modes, it may be useful to combine some of the above supplier response attributes, e.g., as follows: (i) suppliers that deliver on time but high price (assume S1 and S2 meet this combined criteria); (ii) suppliers that deliver late but low price (assume S3 and S4 meet this combined criteria); (iii) suppliers that deliver on time and low price (assume S6 meets this combined criteria); (iv) suppliers that support flexible payment but high price (assume S1 meets this combined criteria); (v) suppliers that supports flexible payment and low price (assume S5 meets this combined criteria); (vi) suppliers that reject commitment based on their capacity (assume S5 meets this combined criteria); (vii) suppliers that deliver material real-time for specific manufacturing and within proximity of manufacturer's factory (assume S1 and S4 meet this combined criteria); and (viii) good relationship with OEM but have history of delaying this specific part (assume S3 and S5 meet this combined criteria).

Accordingly, illustrative embodiments consider that variability can come from factors such as, but not limited to, delivery time, price, flexible payment, real-time delivery option with regional demands, commitment rejection history, part rejection history, and/or relationship. As will be explained in further detail herein, illustrative embodiments consider that each variability factor (also referred to herein as supplier response attributes) can be weighted against the demand mode when computing and/or adjusting demand allocation.

In accordance with illustrative embodiments, another parameter to be considered for the proportional division is market conditions for the suppliers. These conditions are more or less static except for some changes once every six months or a year. This parameter is referred to herein as supplier market behavior (SMB) or supply market value. Some of SMB examples include, but are not limited to: (i) market value of the supplier (e.g., if a drastic reduction, a low percentage of the total demand may be allocated to this supplier); (ii) new supplier in the market for the same parts (e.g., add that supplier to the supplier list and start with small percentage of total demand); (iii) price trend (e.g., if market price is reduced and a specific supplier is not reducing the price, then reduce the percentage of total demand for that supplier); and (iv) capacity to deliver.

Accordingly, illustrative embodiments provide an intelligent demand allocation system and methodologies that compute allocation percentages of a total demand for multiple suppliers based on demand mode and supplier response attributes. Further, in some illustrative embodiments, the allocation percentages is adjusted (e.g., smoothed) using one or more SMB or supply market value factors. For forecasted orders, illustrative embodiments also can predict and suggest an allocation percentage as will be further explained herein.

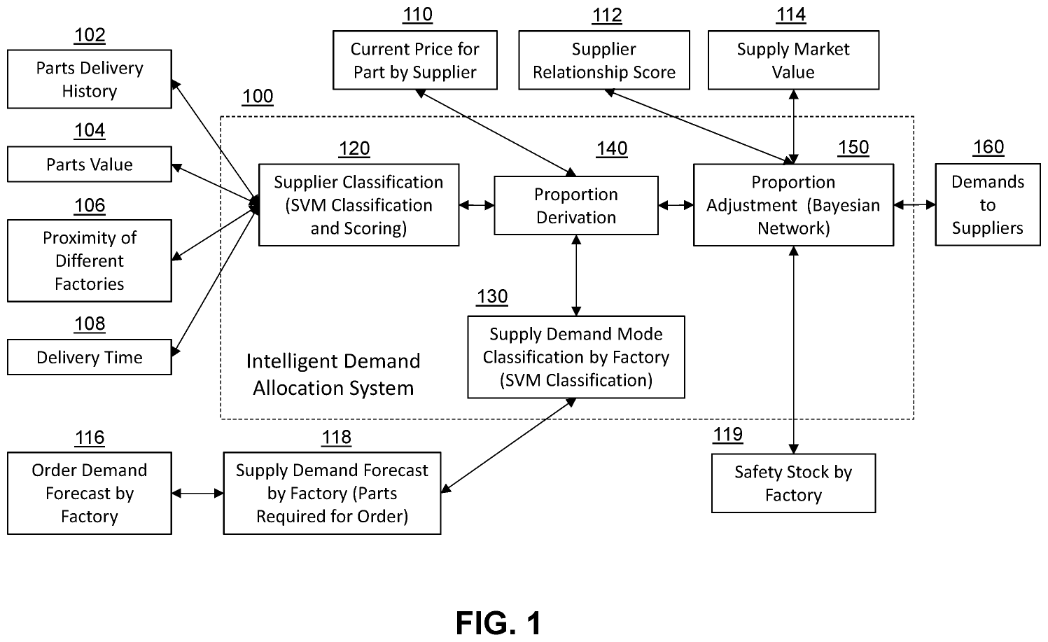

FIG. 1 illustrates an automated supply chain management environment with an intelligent demand allocation system 100 according to an illustrative embodiment. More particularly, as shown, input data obtained by intelligent demand allocation system 100 comprises parts delivery history data 102, a parts value data 104, data on proximity of different factories 106, delivery time data 108, current price data for part by supplier 110, supplier relationship score data 112, supply market value data 114, order demand forecast data by factory 116, supply demand forecast data by factory 118, and safety stock data by factory 119. Intelligent demand allocation system 100 comprises a supplier classification module 120, a supply demand mode classification module 130, a proportion derivation module 140, and a proportion adjustment module 150. Intelligent demand allocation system 100 outputs demands for suppliers 160.

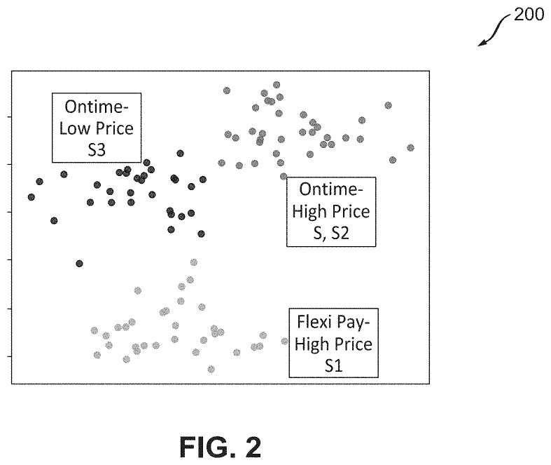

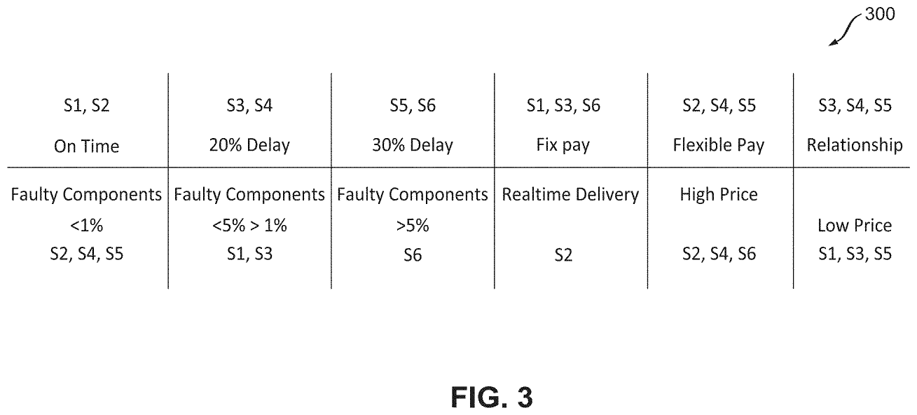

More particularly, supplier classification module 120 uses parts delivery history data 102, a parts value data 104, data on proximity of different factories 106, and delivery time data 108 to classify each of multiple suppliers into one or more supplier response attribute classifications. In one illustrative embodiment, supplier classification can be performed by applying data representing historical delivery history (102), historical parts value (104), historical supplier proximity to factories where subject equipment is being manufactured (106), and historical delivery time (108) for each supplier for all relevant parts and factories to a support vector machine (SVM) classifier and weighted scoring algorithm. The SVM classifier and weighted scoring algorithm determines supplier response attribute classifications for the suppliers. FIG. 2 shows a data cluster graph 200 as an example of how the SVM classifier and weighted scoring algorithm considers conventional data clustering in placing a supplier in one or more supplier response attribute classes. FIG. 3 illustrates a tabular representation 300 of the supplier response attribute classes (on time, 20% delay, 30% delay, etc.) and which suppliers S1, S2, S3, S4, S5 and S6 are assigned to each class. Note again that a supplier can be classified into more than one supplier attribute class, e.g., as per FIG. 3, supplier S3 is in the 20% delay class, the fix pay class, the relationship class, the <5% but >1% faulty component class, and the low price class.

Further, as shown, supply demand mode classification module 130 receives a supply demand forecast data 118 that is derived from an order demand forecast 116. The data received by supply demand mode classification module 130 details the parts required for an order based on the factory that will perform the manufacturing. Supply demand mode classification module 130 utilizes an SVM classification algorithm to generate demand modes for each part. Recall that demand modes represent the criticality of a part to an order, e.g., (i) criticality-low: e.g., an order forecast, a build to stock order; (ii) criticality-medium: e.g., a build to order; and (iii) criticality-high: e.g., a configure to order, a large order, a must arrive by date order.

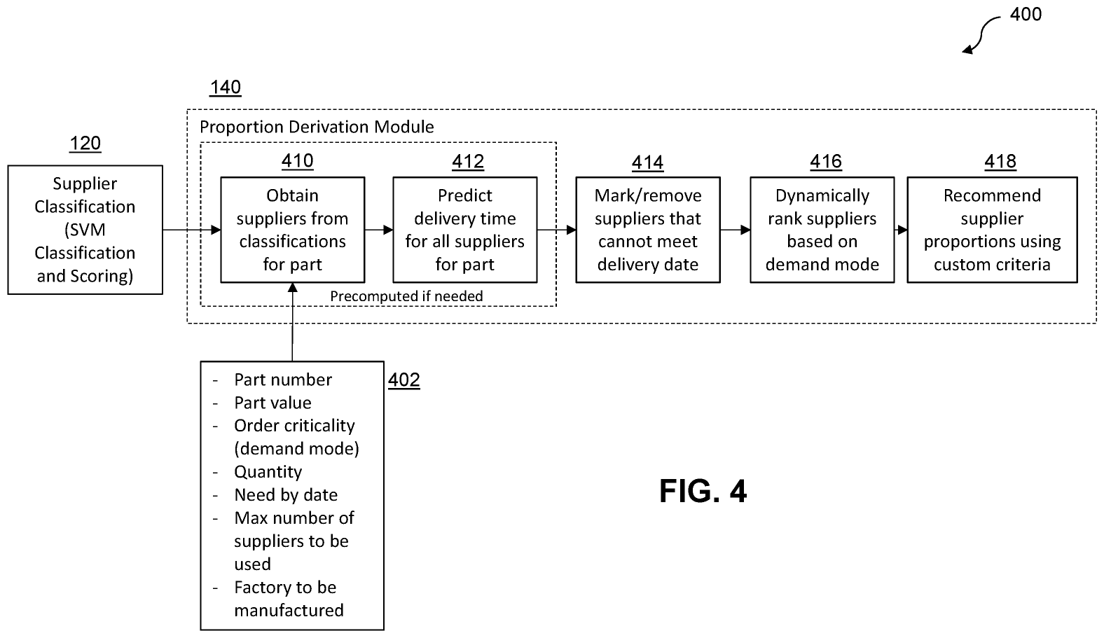

Proportion derivation module 140 inputs the supplier response attribute classes for suppliers from supplier classification module 120, demand modes from supply demand mode classification module 130, and also current price data 110 for each part by supplier. Thus, proportion derivation module 140 inputs the demand modes by part by factory and also obtains the maximum number of suppliers that the supply planner sets to source each given part and, in response, derives a proportion (e.g., percentage) of the total demand to be allocated to each of the selected source suppliers for each given part. In other words, for each part that an OEM needs for fulfilling an equipment manufacturing order for a customer, proportion derivation module 140 inputs data such as part number, value to part, order criticality, quantity, need by date, number of suppliers, and factory of manufacture, and generates what percentage of the total demand each supplier will be allocated. Further details of these and other operations will be explained below in the context of FIG. 4.

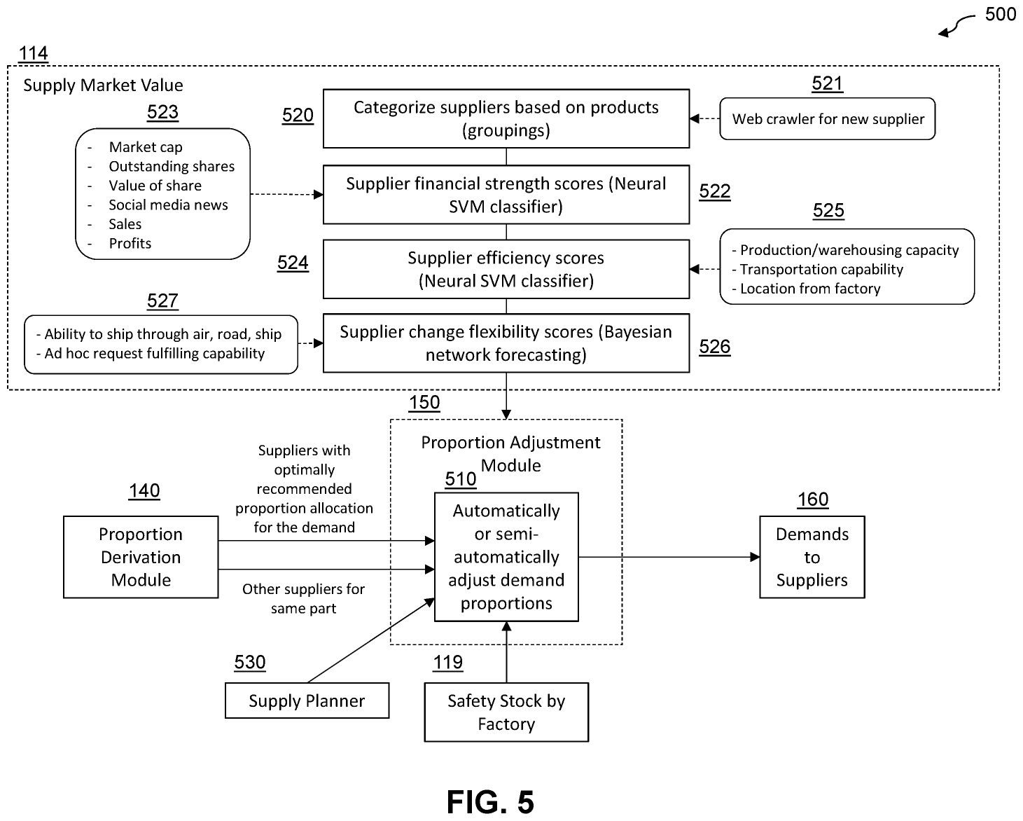

Still further, proportion adjustment module 150 takes the output of proportion derivation module 140 and uses a Bayesian network algorithm to adjust (smooth) the computed percentage allocations based on supply market value 114 (which can represent SMB attributes described above) and safety stock 119 at the factory. The adjusted output of proportion adjustment module 150 is then the output of intelligent demand allocation system 100, i.e., demands for suppliers 160. Further details of these and other operations will be explained below in the context of FIG. 5. These demand allocations are then sent to one or more procurement systems (not expressly shown) that are operatively coupled to intelligent demand allocation system 100 so that the parts can be purchased from the selected source suppliers in the proportions determined by intelligent demand allocation system 100. Note that data is then collected following this parts procurement delivery cycle with regard to the performance of the selected source suppliers and used as historical data by intelligent demand allocation system 100 for a subsequent cycle of parts procurement.

It is to be appreciated that the various ML-based algorithms mentioned above and herein (e.g., SVM, Bayesian network, etc.) are non-limiting examples of conventional intelligent algorithms that can be used to compute demand allocation and other values as described herein.

FIG. 4 illustrates one illustrative embodiment of a process 400 that can be performed by proportion derivation module 140 for a given part in a given order. As shown, step 410 receives input from supplier classification module 120 (as explained above) and data 402 including part number, part value, order criticality (demand mode), quantity, need by date, maximum number of suppliers to be used, and factory where the equipment associated with the order is to be manufactured, and obtains all suppliers from the classifications for the given part. Step 412 predicts a delivery time for all suppliers for the given part. It is to be appreciated that steps 410 and 412 can be precomputed if necessary or desired. Next, step 414 marks and/or removes suppliers that cannot meet the delivery time. Step 416 dynamically ranks suppliers based on demand mode, and step 418 recommends supplier proportions (demand allocations) using criteria that can be customized to the OEM using the system, as explained above.

FIG. 5 illustrates one illustrative embodiment of a process 500 that can be performed by proportion adjustment module 150. As shown, step 510 receives, from proportion derivation module 140, a list of suppliers with an optimally recommended proportion allocation for the demand, as well as a list of other suppliers for the same part. Step 510 then automatically (or semi-automatically, e.g., with additional input from a supply planner if needed or desired) adjusts the demand proportions before they are output as demands for suppliers 160. The adjustment decisions can, at least in part, be made as shown based on the amount of safety stock 119 available at the relevant factory as well as supply market value data 114.

Supply market value data 114 can be derived as further shown in FIG. 5. For example, suppliers can be categorized (grouped) in step 520 based on products with input from a web crawler 521 that can mine for new suppliers. In step 522, supplier financial strength scores can be computed using a neural SVM classifier based on suppliers' public financial data 523 indicative of market cap, outstanding shares, share value, social media news, sales, and profits. Step 524 computes supplier efficiency scores also using a neural SVM classifier based on data 525 indicative of suppliers' production/warehousing capacity, transportation capability, and location (proximity) to the relevant factory. Step 526 computes supplier change flexibility scores using a Bayesian network forecasting based on data 527 indicative of suppliers' ability to ship through multiple shipping mediums (e.g., air, land, sea), as well as their ad hoc request fulfilling capability. One or more of the scores computed in steps 522, 524 and 526 can be used by step 510 to adjust the demand proportions provided by proportion derivation module 140. Also, as explained herein, an administrator or other user, e.g., supply planner 530 in FIG. 5, can provide input to make adjustments.

Given the above illustrative descriptions, consider the following illustrative use case with respect to intelligent demand allocation system 100 for a given part and set of suppliers.

First, proportion derivation module 140 obtains a list of all suppliers who supply the given part, and then forecasts the delivery time (e.g., using a Bayesian network as there can be seasonality changes) of each supplier from the classification to the factory. Proportion derivation module 140 then calculates need by date minus delivery time, and omits the suppliers who cannot deliver by that time. If the time to deliver is greater than the average time of delivery of the suppliers, then three scenarios are possible based on the given demand mode:
(i) If the demand mode is critical, proportion derivation module 140 gives 100% weightage to on time delivery classified suppliers ranked by low price to high price. If there is spillover based on the number of suppliers to be used, proportion derivation module 140 goes to another ranked ascending order by delay in delivery.
(ii) If the demand mode is medium, proportion derivation module 140 gives 100% weightage to on time delivery classified suppliers ranked by low price. If there is spillover, proportion derivation module 140 goes to another ranked ascending order by delay in delivery. This scenario can also be made dependent on the rank of the supplier relationship.
(iii) If the demand mode is low, proportion derivation module 140 sources all suppliers based on the price in descending order with factors of delivery time and relationship as per the supply planner ranking.

Recall the demand example given above where an OEM has five large orders forecasted for next quarter, and the orders must be delivered within two months and include 500 systems (units of equipment), all using high value part X and wherein each system needs two X parts, so the total demand of X is 1000. Recall also that the safety stock of part X in the factory F is 100. Further, recall that there are six suppliers for supplying part X, i.e., suppliers S1, S2, S3, S4, S5 and S6.

Still further recall, using the conventional approach, the supply planner selected S3, S4, and S5 based on price and relationship because the supply planner did not have the visibility of demand mode or other variability factors. As a result, the supply planners demand allocation imposed a risk on 240 parts out of 1000 parts.

In contrast, proportion derivation module 140 of intelligent demand allocation system 100 classifies suppliers based on demand mode. Assume the input to proportion derivation module 140 is as follows:
(i) Part Number: X
(ii) Value to Part: High
(iii) Order Criticality: Critical
(iv) Quantity; 1000
(v) Need by Date: October 30
(vi) Number of Suppliers: 4
(vii) Factory to be manufactured: Factory 1

Proportion derivation module 140 then performs the following steps/computations (as per process 400 in FIG. 4):
(i) Get all suppliers for this part, factory: S1, S2, S3, S4, S5, and S6.
(ii) Compute time to deliver: October 30−Today=45 days.
(iii) Predict the delivery time for all suppliers.
(iv) Remove the suppliers with delays more than 45 days. Thus, S5 and S6 are removed as they are classified in the 30% delay category and predicted to be 52 days for delivery time. S3 and S4 are predicted to be 41 days, so are still under consideration.

Assuming a demand mode of critical, weightage is in descending order as follows:
(i) OnTime
(ii) Price
(iii) Relationship
(iv) <1% faulty components

If critical demand mode, proportion derivation module 140 gets all “Ontime” categorized suppliers, in this case: S1, S2, and S3. S3 is at high price, while S1 and S2 are lower. S2 has a <1% faulty history, Thus, ranking is as follows:
S2—Rank 1 (OnTime, low price, relationship, <1% faulty component)
S1—Rank 2 (OnTime, lower price)
S3—Rank 3 (OnTime)

Proportion derivation module 140 needs one more supplier to meet the desired number of suppliers of four. So proportion derivation module 140 looks for the next best ranking from the rest of the suppliers for low price, i.e., S1, S3, and S5. S1 and S3 already have been selected. S5 has better relationship score but has a 30% delay history. Based on the weighted ranking by the supply planner, proportion derivation module 140 picks S5.

Proportion derivation module 140 thus recommends suppliers S2, S1, S3, S5 according to the ranking, and according to the weightage given for the critical demand mode by the user, the weightage is as follows:
S2—0.55
S1—0.3
S3—0.11
S5—0.03

Accordingly, the following demand allocation for 100 units of part X output by proportion derivation module 140 is:
S2=1000*(0.55)/(0.55+0.3+0.11+0.03)=557
S1=1000*(0.3)/(0.55+0.3+0.11+0.03)=303
S3=1000*(0.11)/(0.55+0.3+0.11+0.03)=111
S5=1000*(0.03)/(0.55+0.3+0.11+0.03)=29

Accordingly, for the critical demand mode, S2 will deliver the majority, with a lower price and on time. S1 and S3 will also deliver the next two largest portions of the demand, respectively, but at a higher price. Thus, the at risk demand is only 29. If a safety stock of 250, the supply planner can opt to keep the demand allocation as it is, as there is a 70% probability that S5 will deliver on time. However, the demand allocation can be adjusted by proportion adjustment module 150 as per FIG. 5 where, inter alia, the supply planner (530) can choose to amend the proportions (e.g., chose not to take the chance of having even 29 units at risk, this part of the demand can be added to the amount S2 will be allocated, e.g., 557+29=586).

Now assume an example of the same part X being used in a build to stock order. Recall that a build to stock order may be defined as a demand mode of low. Proportion derivation module 140 will behave differently since delivery time does not necessarily matter. The weightage for the low demand mode would be mainly given to a supplier with lower price and relationship attributes.

So, the largest part of the demand will go to S5 (low price, relationship, flexible payment) and then S3 (relationship, on time with low price), then S2 (relationship, on time with low price), then to S4 (relationship, higher price, 20% delay). In this example, S2 is not considered at all, and S4 is introduced. As such, proportion derivation module 140 recommends a demand allocation according to the weightage as follows:
S5=1000*(0.45)/(0.45+0.33+0.11+0.01)=500
S3=1000*(0.33)/(0.45+0.33+0.11+0.01)=366
S1=1000*(0.11)/(0.45+0.33+0.11+0.01)=123
S4=1000*(0.01)/(0.45+0.33+0.11+0.01)=11

Accordingly, based on the demand mode, the allocation changes to ensure delivery of high valued and critical orders (maybe with a higher price on occasion) and keeping the price lowest for the low demand mode such as a build to stock order.

As explained above in the context of FIG. 5, this demand allocation view is given to the supply planner with the market view of the suppliers, so that the supply planner can make changes if needed or desired. As the market view may not change frequently, this view may only need to be visible to the supply planner only when there is a change trigger for a specified supplier. That is, the demand allocation recommended by proportion derivation module 140 is smoothened by proportion adjustment module 150 based on the market state of the suppliers, or presented to the supply planner 530 to make an adjustment based on the market suggestion. Advantageously, illustrative embodiments provide a methodology of dividing the total supply needs among the suppliers using classification of the suppliers based on the supplier's historical activities (supplier response attributes) by demand modes, raw material and factory for optimal proportional division. Further, illustrative embodiments provide a proportion derivation module based on demand mode, supplier response attributes, supplier classification and demand/supply forecasting by factory to suggest the supplier ranking and suggested proportion so as to reduce part shortage and costly last-minute (air) shipment.

Illustrative embodiments are described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Cloud infrastructure can include private clouds, public clouds, and/or combinations of private/public clouds (hybrid clouds).

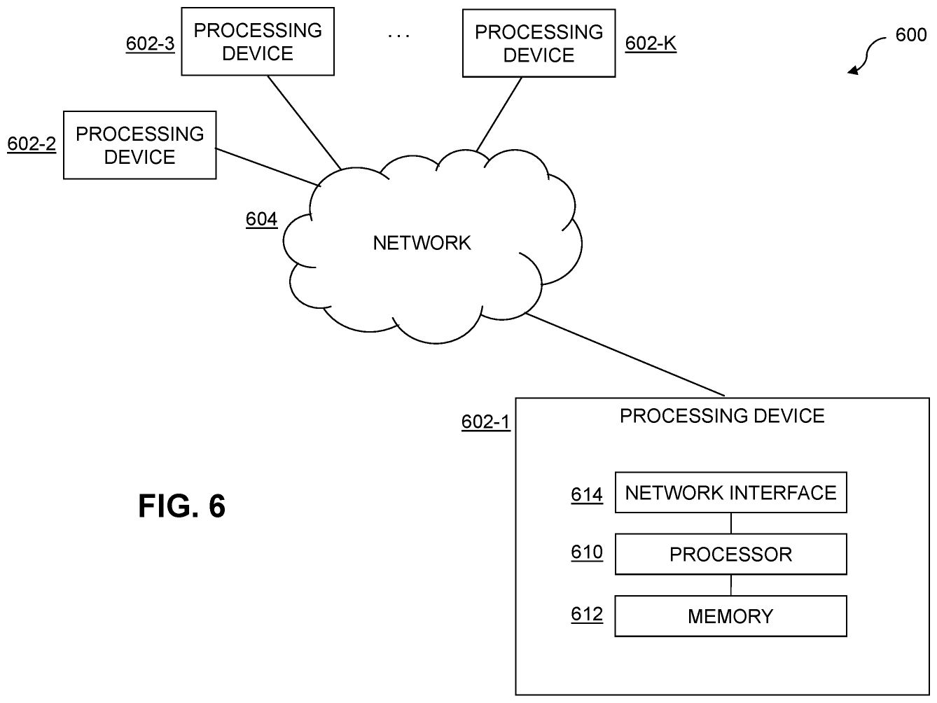

FIG. 6 depicts a processing platform 600 used to implement information processing systems/processes 100 through 500 depicted in FIGS. 1 through 5, respectively, according to an illustrative embodiment. More particularly, processing platform 600 is a processing platform on which a computing environment with functionalities described herein can be implemented.

The processing platform 600 in this embodiment comprises a plurality of processing devices, denoted 602-1, 602-2, 602-3, . . . 602-K, which communicate with one another over network(s) 604. It is to be appreciated that the methodologies described herein may be executed in one such processing device 602, or executed in a distributed manner across two or more such processing devices 602. It is to be further appreciated that a server, a client device, a computing device or any other processing platform element may be viewed as an example of what is more generally referred to herein as a “processing device.” As illustrated in FIG. 6, such a device generally comprises at least one processor and an associated memory, and implements one or more functional modules for instantiating and/or controlling features of systems and methodologies described herein. Multiple elements or modules may be implemented by a single processing device in a given embodiment. Note that components described in the architectures depicted in the figures can comprise one or more of such processing devices 602 shown in FIG. 6. The network(s) 604 represent one or more communications networks that enable components to communicate and to transfer data therebetween, as well as to perform other functionalities described herein.

The processing device 602-1 in the processing platform 600 comprises a processor 610 coupled to a memory 612. The processor 610 may comprise a microprocessor, a microcontroller, an application-specific integrated circuit (ASIC), a field programmable gate array (FPGA) or other type of processing circuitry, as well as portions or combinations of such circuitry elements.

Components of systems as disclosed herein can be implemented at least in part in the form of one or more software programs stored in memory and executed by a processor of a processing device such as processor 610. Memory 612 (or other storage device) having such program code embodied therein is an example of what is more generally referred to herein as a processor-readable storage medium. Articles of manufacture comprising such computer-readable or processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals. Furthermore, memory 612 may comprise electronic memory such as random-access memory (RAM), read-only memory (ROM) or other types of memory, in any combination. The one or more software programs when executed by a processing device such as the processing device 602-1 causes the device to perform functions associated with one or more of the components/steps of system/methodologies in FIGS. 1 through 5. One skilled in the art would be readily able to implement such software given the teachings provided herein. Other examples of processor-readable storage media embodying embodiments of the invention may include, for example, optical or magnetic disks.

Processing device 602-1 also includes network interface circuitry 614, which is used to interface the device with the networks 604 and other system components. Such circuitry may comprise conventional transceivers of a type well known in the art.

The other processing devices 602 (602-2, 602-3, . . . 602-K) of the processing platform 600 are assumed to be configured in a manner similar to that shown for computing device 602-1 in the figure.

The processing platform 600 shown in FIG. 6 may comprise additional known components such as batch processing systems, parallel processing systems, physical machines, virtual machines, virtual switches, storage volumes, etc. Again, the particular processing platform shown in this figure is presented by way of example only, and the system shown as 600 in FIG. 6 may include additional or alternative processing platforms, as well as numerous distinct processing platforms in any combination. Also, numerous other arrangements of servers, clients, computers, storage devices or other components are possible in processing platform 600. Such components can communicate with other elements of the processing platform 600 over any type of network, such as a wide area network (WAN), a local area network (LAN), a satellite network, a telephone or cable network, or various portions or combinations of these and other types of networks.

Furthermore, it is to be appreciated that the processing platform 600 of FIG. 6 can comprise virtual (logical) processing elements implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 600 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It was noted above that portions of the computing environment may be implemented using one or more processing platforms. A given such processing platform comprises at least one processing device comprising a processor coupled to a memory, and the processing device may be implemented at least in part utilizing one or more virtual machines, containers or other virtualization infrastructure. By way of example, such containers may be Docker containers or other types of containers.

The particular processing operations and other system functionality described in conjunction with FIGS. 1-6 are presented by way of illustrative example only, and should not be construed as limiting the scope of the disclosure in any way. Alternative embodiments can use other types of operations and protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the above-described embodiments of the invention are presented for purposes of illustration only. Many variations may be made in the particular arrangements shown. For example, although described in the context of particular system and device configurations, the techniques are applicable to a wide variety of other types of data processing systems, processing devices and distributed virtual infrastructure arrangements. In addition, any simplifying assumptions made above in the course of describing the illustrative embodiments should also be viewed as exemplary rather than as requirements or limitations of the invention.

What is claimed is:

1. An apparatus comprising:
at least one processing device comprising a processor coupled to a memory, the at least one processing device, when executing program code, is configured to:
obtain a demand for a given number of an item associated with a manufacturing order;
obtain a set of classifications for a set of suppliers based on historical data corresponding to each of the suppliers;
obtain a criticality indicator for the demand; and
generate an allocation for the demand across at least a subset of the set of suppliers based on the set of classifications and the criticality indicator, wherein each of the suppliers in the subset is allocated a given proportion of the demand in accordance with the generated allocation.

2. The apparatus of claim 1, wherein the at least one processing device, when executing program code, is further configured to enable adjustment to the generated allocation.

3. The apparatus of claim 2, wherein the at least one processing device, when executing program code, is further configured to enable adjustment to the generated allocation based on at least one of a user input and supply market value data.

4. The apparatus of claim 1, wherein the at least one processing device, when executing program code, is further configured to send the generated allocation for procurement of the given number of the item for the demand associated with the manufacturing order.

5. The apparatus of claim 1, wherein the historical data corresponding to each of the suppliers comprises variability attributes comprising one or more of an item delivery attribute, an item payment attribute, an item rejection attribute, an item price attribute, and a relationship attribute.

6. The apparatus of claim 5, wherein at least some of the set of classifications are computed as a combination of two or more of the variability attributes.

7. The apparatus of claim 1, wherein the at least one processing device, when executing program code, is further configured to obtain the criticality indicator based on a demand forecast for the manufacturing order for a given manufacturing facility.

8. The apparatus of claim 1, wherein the at least one processing device, when executing program code, is further configured to generate the allocation for the demand across the subset of the set of suppliers based on the set of classifications and the criticality indicator by weighting one or more of the set of classifications based on the criticality indicator.

9. The apparatus of claim 1, wherein the at least one processing device, when executing program code, is further configured to generate the allocation for the demand across the subset of the set of suppliers based on the set of classifications and the criticality indicator by computing a forecasted delivery time and removing any supplier from consideration in the allocation unable to satisfy the forecasted delivery time based on the classification of the supplier.

10. The apparatus of claim 1, wherein the at least one processing device, when executing program code, is further configured to:
obtain the set of classifications and the criticality indicator based on one or more machine learning-based algorithms.

11. A method comprising:
obtaining a demand for a given number of an item associated with a manufacturing order;
obtaining a set of classifications for a set of suppliers based on historical data corresponding to each of the suppliers;
obtaining a criticality indicator for the demand; and
generating an allocation for the demand across at least a subset of the set of suppliers based on the set of classifications and the criticality indicator, wherein each of the suppliers in the subset is allocated a given proportion of the demand in accordance with the generated allocation;
wherein the obtaining and generating steps are performed by at least one processing device comprising a processor coupled to a memory when executing program code.

12. The method of claim 11, further comprising enabling adjustment to the generated allocation.

13. The method of claim 12, wherein enabling adjustment to the generated allocation is based on at least one of a user input and supply market value data.

14. The method of claim 11, further comprising sending the generated allocation for procurement of the given number of the item for the demand associated with the manufacturing order.

15. The method of claim 11, wherein the historical data corresponding to each of the suppliers comprises variability attributes comprising one or more of an item delivery attribute, an item payment attribute, an item rejection attribute, an item price attribute, and a relationship attribute.

16. The method of claim 15, wherein at least some of the set of classifications are computed as a combination of two or more of the variability attributes.

17. The method of claim 11, wherein obtaining the criticality indicator is based on a demand forecast for the manufacturing order for a given manufacturing facility.

18. The method of claim 11, wherein generating the allocation for the demand across the subset of the set of suppliers based on the set of classifications and the criticality indicator further comprises weighting one or more of the set of classifications based on the criticality indicator.

19. The method of claim 11, wherein generating the allocation for the demand across the subset of the set of suppliers based on the set of classifications and the criticality indicator further comprises computing a forecasted delivery time and removing any supplier from consideration in the allocation unable to satisfy the forecasted delivery time based on the classification of the supplier.

20. A computer program product comprising a non-transitory processor-readable storage medium having stored therein program code of one or more software programs, wherein the program code when executed by at least one processing device cause the at least one processing device to:
obtain a demand for a given number of an item associated with a manufacturing order;
obtain a set of classifications for a set of suppliers based on historical data corresponding to each of the suppliers;
obtain a criticality indicator for the demand; and
generate an allocation for the demand across at least a subset of the set of suppliers based on the set of classifications and the criticality indicator, wherein each of the suppliers in the subset is allocated a given proportion of the demand in accordance with the generated allocation.
